(19) United States
(12) Patent Application Publication
(10) Pub. No.: US 2025/0133372 A1
(43) Pub. Date: Apr. 24, 2025

(54) SYSTEM AND METHOD FOR COMMUNICATING THROUGH MULTIPLE ENDPOINTS

(71) Applicant: Twilio Inc., San Francisco, CA (US)

(72) Inventors: Patrick Malatack, San Francisco, CA (US); Gowri Rao, San Francisco, CA (US); Kenneth Hoxworth, San Francisco, CA (US); Elaine Tsai, San Francisco, CA (US); Saurabh Daftary, Concord, CA (US); Triet Kha, San Francisco, CA (US); Julie Laver, San Francisco, CA (US)

(21) Appl. No.: 19/006,041

(22) Filed: Dec. 30, 2024

Related U.S. Application Data
(63) Continuation of application No. 17/688,827, filed on Mar. 7, 2022.
Application No. 17/688,827 is a continuation of application No. 16/535,828, filed on Aug. 8, 2019, now Pat. No. 11,272,325.
Application No. 16/535,828 is a continuation of application No. 15/154,752, filed on May 13, 2016, now Pat. No. 10,419,891.
(60) Provisional application No. 62/243,795, filed on Oct. 20, 2015.
(60) Provisional application No. 62/161,726, filed on May 14, 2015.

(51) Int. Cl. H04W 4/06; H04W 4/02; H04W 4/14

(52) U.S. Cl. CPC H04W 4/06; H04W 4/025; H04W 4/14

(57) ABSTRACT

A system and method for a communication system that includes receiving, through an application programming interface, a set of communication requests directed at an endpoint pool resource, the endpoint pool resource including a set of account phone numbers associated with an account, the set of communication requests specifying a set of destination phone numbers, for each destination phone number in the set of destination phone numbers, selecting an account phone number from the set of account phone numbers based on a phone number type of a plurality of phone number types, and initiating outbound communication with the destination phone number from an origin endpoint assigned as the selected account phone number.

### CROSS-REFERENCE TO RELATED APPLICATIONS

This application is a continuation application of co-pending U.S. patent application Ser. No. 17/688,827, filed Mar. 7, 2022, which is a continuation of U.S. patent application Ser. No. 16/535,828, filed Aug. 8, 2019, now U.S. Pat. No. 11,272,325, which is a continuation application of U.S. patent application Ser. No. 15/154,752, filed on May 13, 2016, now U.S. Pat. No. 10,419,891, which claims the benefit of U.S. Provisional Application No. 62/161,726, filed on May 14, 2015, and U.S. Patent Application No. 62/243,795, filed on Oct. 20, 2015, each of which is incorporated herein by reference.

### TECHNICAL FIELD

This invention relates generally to the communication field, and more specifically to a new and useful system and method for communicating through multiple endpoints in the communication field.

### BACKGROUND

Numerous services and applications leverage text and media messaging (e.g., SMS and MMS) in communicating with customers. SMS and MMS enable a large number of people to be reached using existing telecommunication infrastructure. However, contacting a large volume of customers over SMS and MMS is limited by the messaging limits placed on such messaging systems. SMS messages sent from a longcode phone number are rate limited to only one message per second by carriers. Many applications require the ability to message a large number of people within a given time window. Thus, there is a need in the communication field to create a new and useful system and method for communicating through multiple endpoints. This invention provides such a new and useful system and method.

### BRIEF DESCRIPTION OF THE FIGURES

FIG. 1 is a schematic representation of a system of a preferred embodiment;

FIG. 2 is an exemplary screenshot of an endpoint management portal;

FIG. 3 is a flowchart representation of a method of a preferred embodiment;

FIG. 4 is an exemplary screenshot of an endpoint management portal with a capacity limit preview;

FIG. 5 is a schematic representation of a variation of the method wherein multiple communication requests are received;

FIG. 6 is a schematic representation of a variation of the method wherein one communication request specifies multiple destinations are received;

FIGS. 7-10 are flowchart representations of variations of selecting a communication endpoint; and

FIGS. 11A-11D are detailed flowchart representations of an exemplary selection heuristic.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Communicating Through Multiple Endpoints

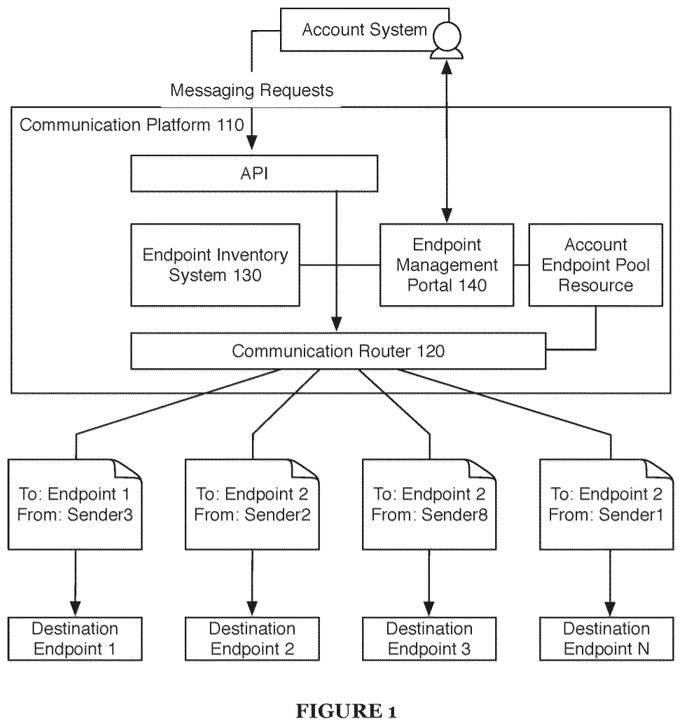

As shown in FIG. 1, a system for communicating through multiple endpoints can include a communication platform 110, a communication router 120, an endpoint inventory system 130, and an endpoint management portal 140. The system functions to enable a pool of telephony endpoints to be intelligently shared in establishing communications. The system is preferably used in sending messages but may additionally or alternatively be used for establishing synchronous media sessions such as voice or video calls. Herein, messaging is used as the main exemplary use case and is not in any way meant to limit the system or method to messaging. As one potential benefit of the system, the rate limits of outgoing communications for a single endpoint can be avoided by using fallback endpoints. An additional potential benefit is that a contextually appropriate endpoint can be selected for each destination endpoint. In one exemplary use-case scenario, the system is used by a customer building a messaging service that needs to reach a large number of participants. For example, an airline notification service may need to send a large number of messages in a short amount of time to inform passengers of flight changes. In another example, a social-commerce service may need to maintain messaging capacity while sending SMS and MMS messages to users throughout the day.

The communication platform no functions to provide communication services to developer applications and services. The system is preferably implemented in combination with a communication platform 110 such as the one described in patent application Ser. No. 12/417,630 filed 2 Apr. 2009, entitled “System and Method for Processing Telephony Sessions”, which is hereby incorporated in its entirety by this reference. The communication platform no preferably enables application execution in connection to communication sessions and/or messages; the communication platform 110 may additionally or alternatively provide an application programming interface (API) as an alternative for interacting with communication functionality of the communication platform no. The communication platform 110 can be designed for one or more mediums of communication. The communication platform 110 preferably includes SMS and MMS messaging capabilities, but may alternatively or additionally include other asynchronous messaging functionality and/or synchronous communication capabilities (e.g., PSTN calls, IP voice calls, IP video calls, screen sharing, and the like).

The communication platform no is preferably a multitenant communication platform that allows multiple entities to use the communication platform 110 in facilitating communication tasks. An entity can be an account, subaccount, or any suitable identifier for a party. The communication platform 110 can additionally be a cloud-hosted platform. The communication platform 110 can be a server, a server cluster, a collection of computing resources on a distributed computing system, or any suitable network accessible computing infrastructure. The system may alternatively be used in combination with a text or multi-media based messaging system, a video or voice chat system, a screen-sharing system, and/or any suitable communication platform no.

The communication router 120 functions to send communications to a destination endpoint from an origin endpoint (i.e., sending endpoint). The communication router 120 can include an outbound communication transmission interface, from which outgoing communications are sent. The outgoing communications preferably include SMS and/or MMS messages, but may alternatively include IP Messages, third-party platform communications (e.g., social network messaging), voice calls, or any suitable medium of communication. The communication router 120 can additionally include an inbound communication interface through which inbound communications can be received and appropriately routed. The system can support managing inbound responses to outbound messages and/or responding to inbound new communications. The communication router 120 can include a number of communication route options, which may enable transmitting communications over varying protocols, to different regions, and with different telecommunication carrier services. The communication router 120 may support global communication to a plurality of countries and region. The communication router 120 may alternatively be limited to a select region and/or set of communication mediums.

The endpoint inventory system 130 functions to manage endpoint allocation and assignment for a set of entities. The communication platform no may manage a set of endpoints that can be assigned, allocated, and/or used by an entity. An entity within the communication platform no can preferably register with a set of endpoints. The endpoint inventory system 130 can enable a user to purchase or register different endpoints, and the endpoint inventory system 130 can enable a user to release or remove endpoints from their account. The endpoint inventory system 130 can manage a set of unallocated endpoints available for registration. A user can browse and select a set of endpoints to associate with an account. Endpoints may additionally or alternatively be ported in from outside registration. For example, an entity may onboard an existing, outside phone number into the endpoint inventory system 130 for using the phone number with the communication platform no. Endpoints can be purchased through a programmatic interface (e.g., a REST API), a graphical user interface, and/or any suitable interface. The endpoint inventory system 130 may alternatively or additionally manage a set of shared endpoints, which may be used across a set of entities. The endpoint inventory system 130 can additionally include an autoallocation system, which may add endpoints to an account when particular conditions are satisfied. For example, an entity can pre-register for an endpoint with a particular number pattern, area code, or country code. When an endpoint becomes available the autoallocation system adds the endpoint to the entity. The autoallocation system can manage endpoint request queuing across multiple accounts, which functions to fairly assign endpoints across endpoints during autoallocation.

An endpoint is preferably a telephony address (e.g., a phone number). A telephony endpoint can be a longcode phone number, a short code, toll-free numbers, alphanumeric endpoints, or any suitable telephony address. The endpoints may be for a single country but can alternatively be for a set of different countries. Alternative types of endpoints may additionally be supported. Alternative endpoints may include email addresses, usernames for third-party communication service, or addressing information for any suitable communication channel. The endpoints may have associated communication restrictions and properties. A communication restriction can be a rate limit on how quickly messages can be sent within a short time frame (e.g., 5 messages per minute), a volume limit on total number of messages in a long time window (e.g., 100 messages in one hour), content limits, and/or any suitable restriction. Properties of an endpoint may include carrier, content encoding approach, and/or any suitable property.

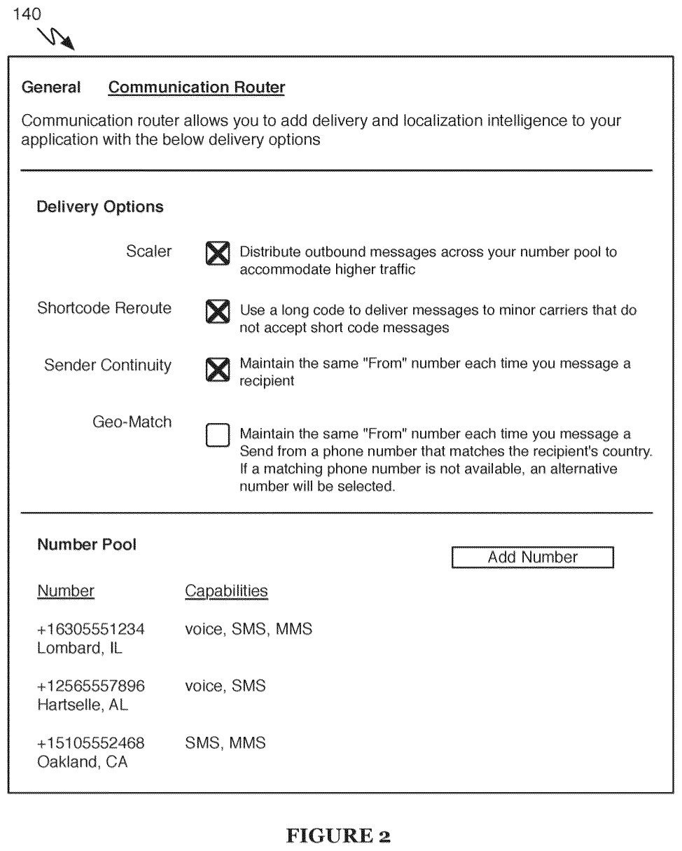

The endpoint management portal 140 functions to enable an account to configure how a group of account endpoints can be cooperatively used in communicating. The endpoint management portal 140 is preferably used in setting up messaging endpoint pools as shown in FIG. 2. A messaging endpoint pool as described above enables messages to be transmitted using multiple endpoints in response to messaging requests or one bulk message from an account. A user can preferably create an endpoint pool resource. The endpoint pool resource includes a list of endpoints. The endpoint pool resource can additionally include endpoint distribution configuration such as endpoint prioritization, endpoint continuity configuration, geographic matching configuration, autoallocation configuration, shared pool configuration, and/or any suitable endpoint pool usage setting. Endpoint prioritization can determine the prioritization of an individual endpoint or a type of endpoint. For example, a short code endpoint can be prioritized ahead of a longcode endpoint. Endpoint continuity configuration enables an endpoint to default to a previously used origin endpoint if the destination endpoint has been previously contacted. When activated, geographic matching prioritizes endpoints based on matching country code, matching area code, or regional proximity of an endpoint. Autoallocation enables endpoints to be automatically added and/or deallocated from an endpoint pool to satisfy communication requirements. Shared pools can enable a shared pool of endpoints to be used to satisfy communication requirements when a pool of endpoints doesn't provide sufficient capacity. The endpoint pool resource is preferably accessed and used in instructing the communication router 120 in how to send communications. In one variation, the endpoint pool resource can be modified and updated over an API. In another variation, the endpoint pool resource can be modified and updated through a graphical user interface.

### 2. Method for Communicating Through Multiple Endpoints

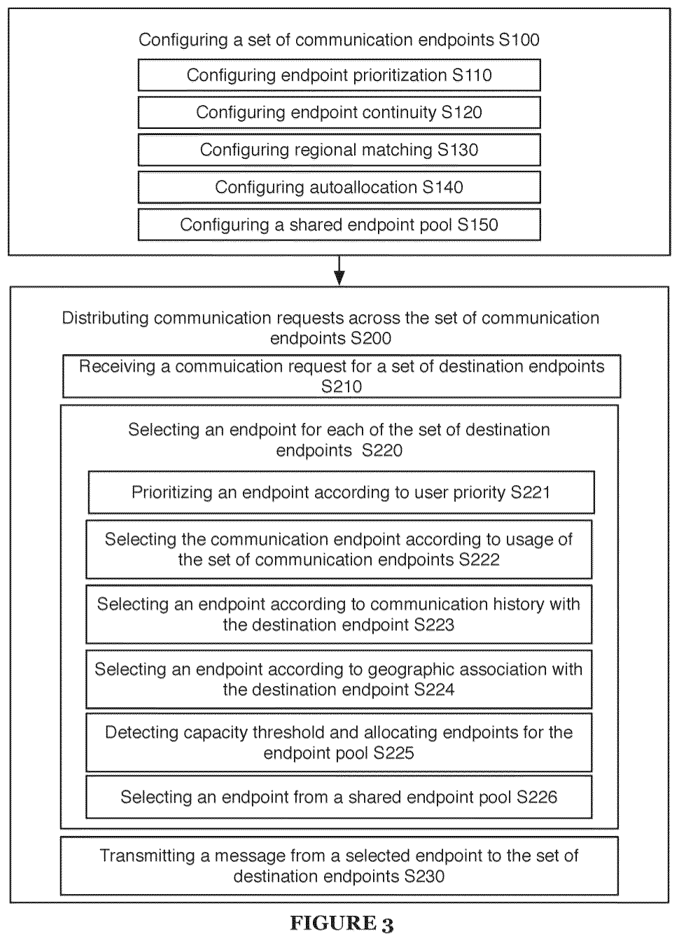

As shown in FIG. 3, a method for communicating through multiple endpoints can include configuring a set of communication endpoints S100 and distributing communication requests across the set of communication endpoints S200. The method functions to enable a pool of telephony or communications endpoints to be intelligently shared in sending messages or establishing communications within a time window. The method is preferably applied within a multi-tenant communication platform. An entity of the platform (e.g., an account) can make multiple communication requests and/or one or more bulk communication requests. The method automates the process of determining which origin endpoint should be used in sending a communication to a particular destination. The method is preferably utilized with rate limited or usage restricted endpoints so as to avoid or mitigate restrictions. The method is preferably applied to SMS messaging, MMS messaging, and/or any suitable rate limited communication protocol. For example, SMS and MMS may have rate limits (e.g., number of messages per minute) and/or volume caps (e.g., total messages sent in one hour, day, or month). The method may additionally include variations that involve making automated calls, sending a message over a third-party communication protocol, or initiating any suitable type of communication. A call can be a PSTN voice call, a SIP call, an IP media call (voice, video, screen sharing, or data), or any suitable type of call. The method is primarily described as applying to messaging, but may alternatively be applied to other communication modes. The method can be used across a plurality of entities. Each entity can have a unique configuration for a set of communication endpoints. The method can be implemented by the system above, but any suitable system may be used.

Block S100, which includes configuring a set of communication endpoints, functions to setup a group of endpoints that can be used in sending messages to a plurality of destinations. An entity can configure an endpoint pool resource with a set of account managed communication endpoints, which may be owned, rented, or otherwise controlled endpoints. Configuring a set of communication endpoints preferably includes adding a subset of entity endpoints to an endpoint pool. An endpoint pool can be a referencable resource (e.g., an identifiable REST API resource), an account setting, or any suitable data construct. In one variation, an entity may configure a single endpoint pool associated with the entity. Alternatively, an entity may configure multiple endpoint pools wherein each endpoint pool can have distinct and customized configuration. The set of communication endpoints in an endpoint pool can include local endpoints, longcode endpoints, endpoints from multiple area codes, endpoints with multiple country codes, shortcodes, alphanumeric endpoints, and/or any suitable type of endpoint address. Configuration of the endpoint pool is preferably made through a website but may alternatively be made through an application or a programmatic interface (e.g., REST API).

A programmatic interface is preferably a RESTful API but may alternatively be any suitable API such as SOAP or custom protocol. The RESTful API works according to an application layer request and response model. An application layer request and response model may use an HTTP-based protocol (HTTP or HTTPS), SPDY, or any suitable application layer protocol. Herein, HTTP may be used, but should not be interpreted as being limited to the HTTP protocol. HTTP requests (or any suitable request communication) to the communication platform preferably observe the principles of a RESTful design. RESTful is understood in this document to describe a Representational State Transfer architecture as is known in the art. The RESTful HTTP requests are preferably stateless, thus each message communicated contains all necessary information for processing the request and generating a response. The API service can include various resources, which act as referenced objects that can act as a mechanism for specifying requested information or requesting particular actions. The resources can be expressed as URI's or resource paths. The RESTful API resources can additionally be responsive to different types of HTTP methods such as GET, Put, POST and/or DELETE. An entity may create and configure an endpoint pool by making a HTTP requests. Similarly, an entity may request a new communication by referencing the endpoint pool when making an HTTP request.

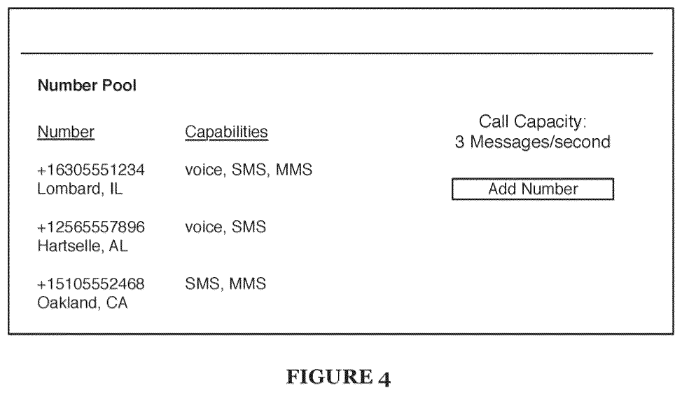

An account holder preferably adds a sufficient number of endpoints to satisfy expected messaging capacity requirements. The method may include presenting a preview of communication capacity capabilities in response to configuring a set of communication endpoints, which functions to provide user feedback for evaluating capacity capabilities of an endpoint pool. Presenting a preview may include simulating and/or calculating limits, which are presented in a report as shown in FIG. 4. In one variation, basic capacity information can be evaluated and reported through an endpoint management portal. For example, as a user adds endpoints to the endpoint pool, a call capacity meter may increase. The call capacity may be number of messages that can be transmitted in a set time window (e.g., one hour). In another variation, a user may specify a specific messaging scenario, which may include the number of messages and a time window. The messaging scenario may additionally specify geographic region. The communication capacity of the endpoint pool for the user specified messaging scenario could be similarly presented. A preview of communication capacity capabilities can include global or general communication capacity and/or regional capacity.

Preferably, an endpoint pool is configured by an entity explicitly adding communication endpoints to the endpoint pool. In one alternative approach, an entity could configure the set of communication endpoints by specifying communication capacity guidelines. In this alternative approach, configuring a set of communication endpoints can include receiving communication capacity guidelines and automatically allocating communication endpoints to the set of communication endpoints. Automatically allocating communication endpoints selects recommended communication endpoints such that as a set the communication endpoints are better equipped to satisfy the communication capacity. A set of communication endpoints can additionally be configured through a mixture of the two approaches where a subset of communication endpoints are specifically added while a second subset are automatically allocated to the entity (e.g., purchased or otherwise assigned) and added to the set of communication endpoints.

Configuring an endpoint pool with a set of communication endpoints can additionally include configuring endpoint distribution configuration, which functions to define the capabilities and process of distributing communication requests. Configuring an endpoint distribution configuration may include configuring endpoint prioritization S110, configuring endpoint continuity S120, configuring regional matching S130, configuring autoallocation S140, and/or configuring a shared endpoint pool S150. An account holder or other administrator of an entity can enable various features and optionally set operating parameters of an endpoint distribution configuration. Some or all of the endpoint distribution configurations may be set by default and some may be configured by a second party such as the communication platform.

Configuring endpoint prioritization S110 functions to set prioritization of different endpoints or types of endpoints. In one variation, a user can configure shortcode prioritization wherein shortcodes are automatically prioritized over longcodes. Similarly, alphanumeric endpoints may be prioritized relative to shortcodes and longcodes. A user may alternatively individually specify the prioritization of a subset or all endpoints in the endpoint pool. Prioritization of endpoints may be predefined in the business logic of distributing communication requests across the set of communication endpoints.

Configuring endpoint continuity S120 functions to reuse the same origin endpoint for contacting a destination endpoint that previously received a communication from the account. Use of an origin endpoint can be made “sticky” for a destination address—the same origin endpoint can be used when contacting a destination address multiple times. Endpoint continuity makes for a consistent experience to recipients of communications. For example, when a company sends a communication to a particular destination endpoint, the same origin endpoint for subsequent communications is used. Endpoint continuity can be enabled or disabled. Endpoint continuity can additionally be enabled or disabled for various subsets or types of destination endpoints. Endpoint continuity may be prioritized during the selection of an endpoint. For example, in one implementation, endpoint continuity may be broken when a regional matched endpoint is available during a subsequent communication. For example, the first time a customer is contacted the endpoint may have a limited number of endpoints. More endpoints may be added after the first message. A subsequent message may use an endpoint with a closer regional proximity to the destination. In another exemplary implementation, continuity may be prioritized above regional matching.

There may be scenarios where a destination endpoint may not receive a communication from a consistent endpoint even when endpoint continuity is active. For example, the last used origin endpoint may be at capacity and can't be used. As a result a destination endpoint may have been contacted by the entity through a plurality of different origin endpoints Various operating modes may be used during endpoint continuity such as last used mode, first used mode, most used mode, geographically nearest mode, and best fit mode.

In a last used mode, an attempt is made to maintain endpoint continuity based on the last used origin endpoint. If the new origin endpoint has to be used, then that new origin endpoint will be prioritized the next time. Last used mode can be implemented by storing the last used endpoint.

In a first used mode, endpoint continuity prioritizes the first endpoint used to contact a recipient.

In a most used mode, the origin endpoint used the most when contacting a recipient is prioritized.

In a geographically nearest mode, an origin endpoint from all the previously used origin endpoints is prioritized based on geographically proximity or association to the destination endpoint.

In a best fit mode, an origin endpoint of the set of previously used origin endpoints is prioritized based on some set of heuristics such as geographic association, order of usage, frequency of usage.

The endpoint continuity may be stored and made accessible as a programmatic resource. In one variation, the endpoint continuity may be inspected, changed, and/or deleted (i.e., reset).

Configuring regional matching S130 functions to bias endpoint selection based on regional proximity to a destination endpoint. Regional matching can be a binary feature. When enabled, regional matching is applied in block S200. When disabled, there is no regional matching. Alternatively, there may be conditional regional matching. In one variation, the regional matching includes a regional threshold wherein regional matching is only used if an origin endpoint can be used with a regional association satisfying some proximity condition. A proximity condition could include a defined set of acceptable area or country codes. In the extreme example, the country code and area code of the origin endpoint must match the country and area code of the destination endpoint. A proximity condition can be based on displacement between the associated geographic regions. For example, regional matching is used if an origin endpoint can be used if one within fifty miles is available, and otherwise any endpoint maybe used.

Regional matching may include various approaches. There can be country matching, which biases endpoint selection towards endpoints with the same country code. There can be area code matching, which biases endpoint selection towards endpoints with the same country code. There can be closest proximity matching, which biases endpoint selection towards area codes or country codes nearest to a region associated with the destination endpoint.

Configuring autoallocation S140 functions to allow the set of endpoints in an endpoint pool to be increased or decreased automatically. When enabled, autoallocation will result in automatic allocation of endpoints for an account to satisfy messaging capacity requirements. Autoallocation can additionally release endpoints when the endpoints are no longer needed. Similarly, a shared endpoint pool can be enabled through block S150, which enables messages for an account to use origin endpoints that are part of a maintained pool of shared endpoints. The shared endpoints can be shared by two or more accounts.

Block S100 may additionally enable other aspects of an endpoint pool to be configured. For example, the response to a text reply can be configured. A text reply may be used in selecting different options or issuing a command. For example, a message recipient may reply with “STOP”. The response to the reply of “STOP” may be defined across all endpoints of the endpoint pool.

Block S200, which includes distributing communication requests across the set of communication endpoints, functions to use the set of communication endpoints and their configuration to send messages to a set of different destinations. The configuration of the set of communication endpoints is preferably invoked to determine how outbound communication requests are transmitted. In a low capacity scenario, a high priority endpoint can be selected. When the number of communications (e.g., messages sent) begins exceeding the communication restrictions (e.g., messaging rate) of a single endpoint, alternative endpoints from the endpoint pool are selected and used to send a communication. By distributing communications across multiple endpoints, messages can be transmitted at a rate exceeding that of the communication restrictions for an individual endpoint. Distributing communication requests across the set of communication endpoints can include receiving a communication request for a set of destination endpoints S210, selecting a communication endpoint for each of the set of destination endpoints S220, and establishing a communication to a destination endpoint from the associated selected communication endpoint S230. The communication can be made agnostic to the particular origin endpoint. The method can dynamically determine an appropriate origin endpoint based on various rules and configurations for an endpoint pool of an entity.

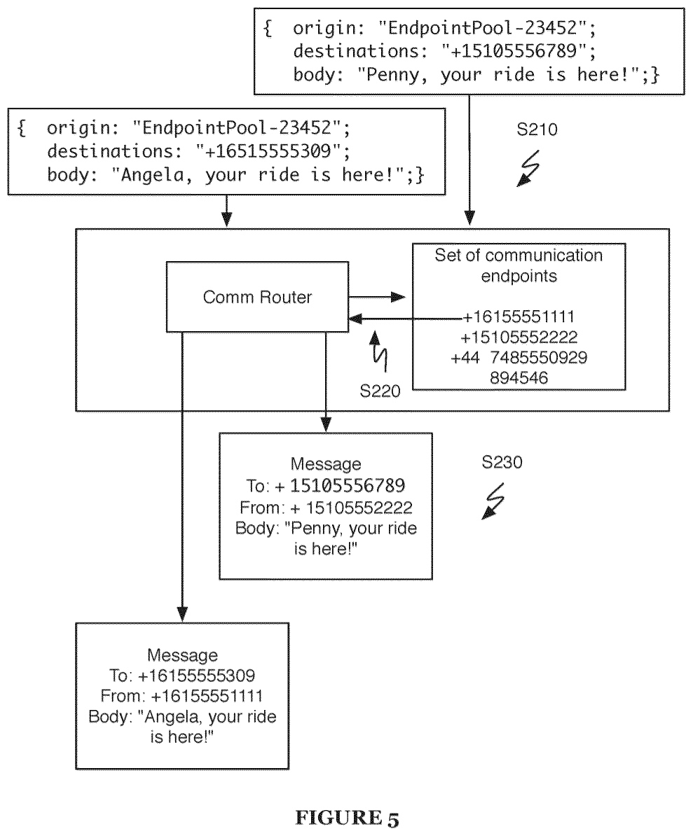

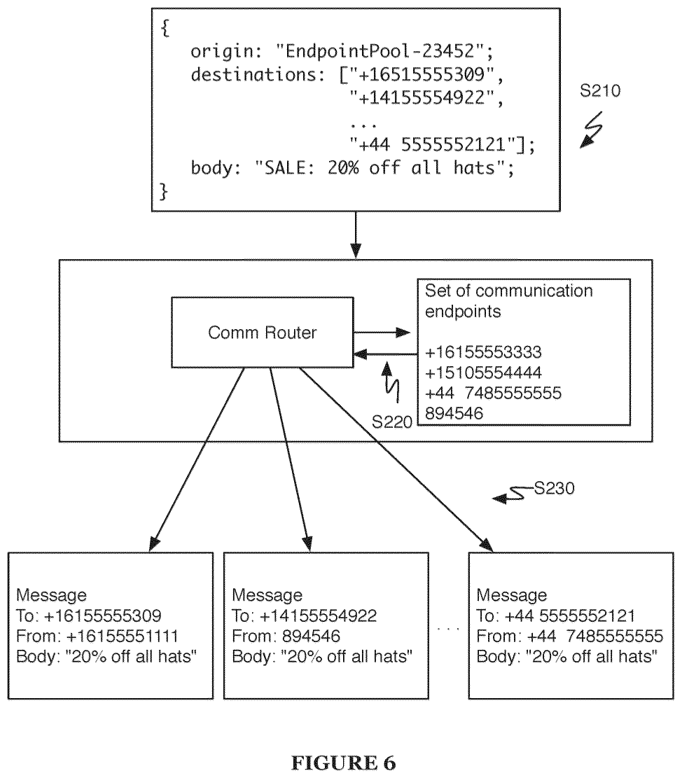

Block S210, which includes receiving a communication request for a set of destination endpoints, functions to initiate a plurality of outbound messaging requests. A communication request can be an asynchronous messaging request that specifies at least one destination endpoint and content to be communicated to multiple destination endpoints. A messaging request may correspond to an SMS, MMS, or IP messaging request. The message content can be a text body, a media file, multimedia, or any suitable form of content. A communication request could alternatively be synchronous communication request that specifies at least one destination endpoint. A synchronous communication request may establish a voice call, a video call, a screen sharing session, or any suitable real time communication session. In one variation, a set of communication endpoints is referenced through an endpoint pool resource identifier. For example, a programmatically received messaging request may include the destination endpoint(s), the content, and an endpoint pool identifier as shown in FIGS. 5 and 6.

The method can preferably be used in a variety of scenarios where multiple communications need to be established. Multiple distinct communication requests may be received from an entity over a set time period as shown in FIG. 5. The distinct communication requests may have different message content. The method can enable automatic distribution of communications according to the configuration of the set of communication endpoints. Additionally or alternatively, a single communication request may direct multiple, distinct communications to be established with multiple destination endpoints, where the single communication request functions as a bulk communication request as shown in FIG. 6. The method can additionally handle a combination of multiple communication requests wherein a subset of the communication requests are bulk communication requests.

In one variation, a communication request may include a request expiration property. A request expiration property functions to define the time that the request should be active. An expiration property is preferably a time window. A request expiration property may alternatively be any suitable testable condition. An entity may include a request expiration property when a bulk messaging request is only relevant if sent within a short time window. Any messages not sent after the time window will be canceled and not sent.

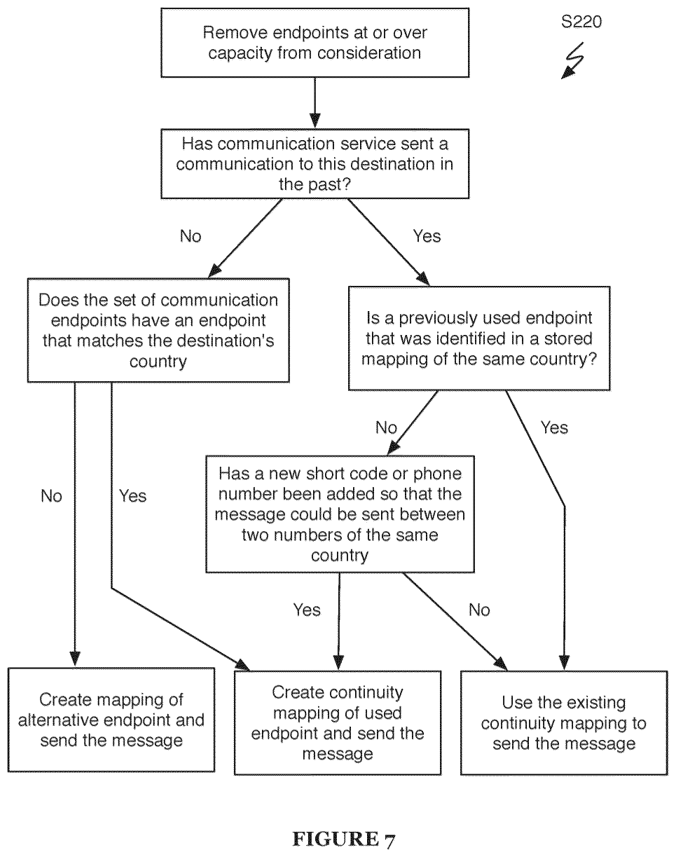

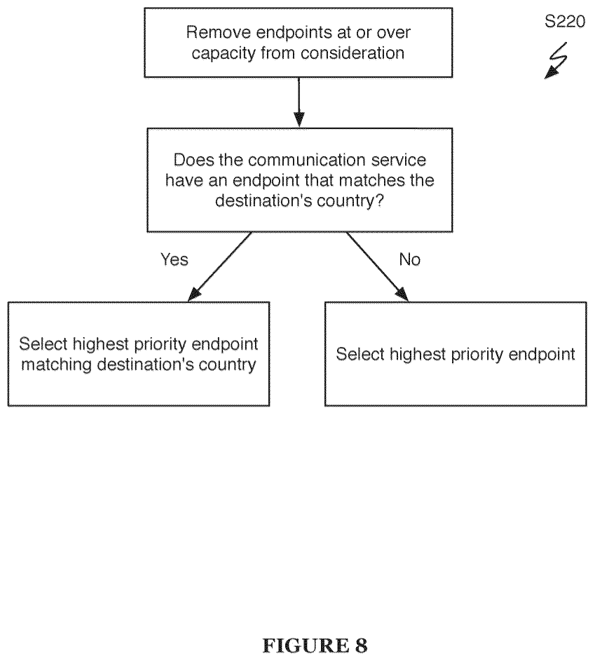

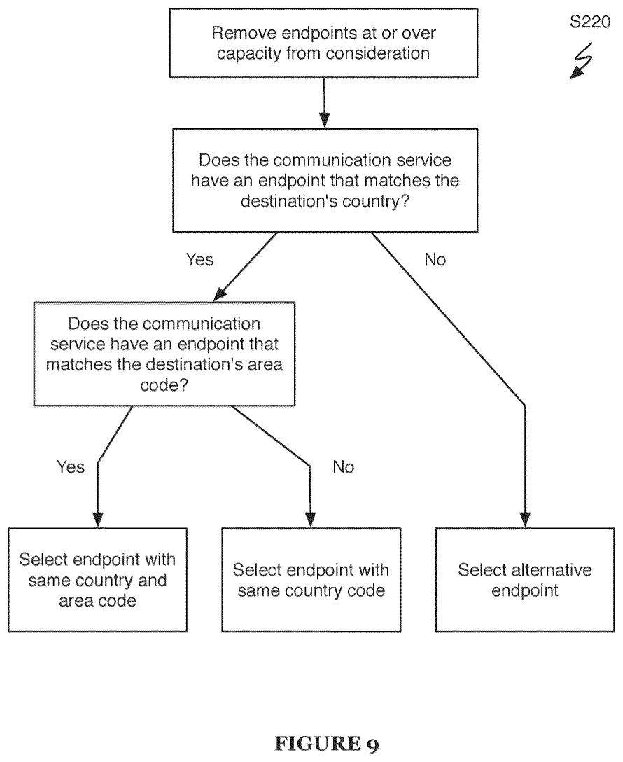

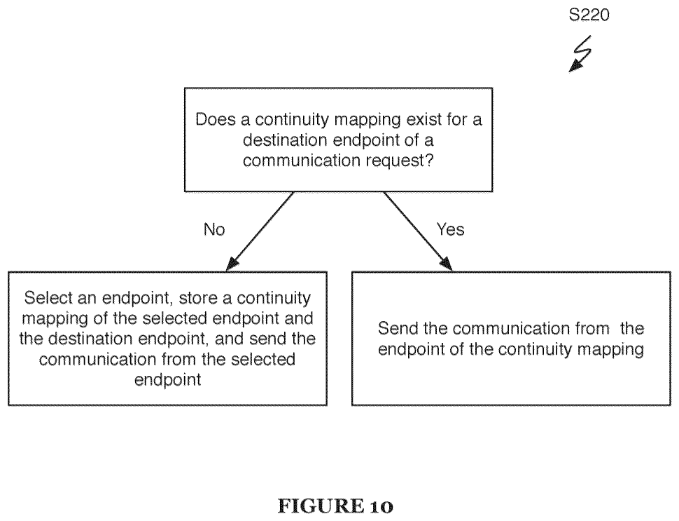

Block S220, which includes selecting a communication endpoint for each of the set of destination endpoints, functions to select preferred endpoints while distributing endpoint usage to avoid rate limiting, create a consistent communication experience, or promote other benefits from intelligent origin endpoint selection. The configuration of the set of communication endpoints of an entity is preferably used in determining the process of selecting an endpoint. As described, an endpoint pool resource (or any suitable reference to configuration of the set of communication endpoints) may be made. Alternatively, the configuration may be directly associated with the entity making the request such that no explicit reference to the configuration may be required in the request. In addition to configuration, properties of a destination endpoint and communication history may be used. Any suitable processing and logic may be used. The various selection processes and/or any suitable alternative processes may be used in any suitable process. Preferably, selecting a communication utilizes endpoint continuity, endpoint prioritization, regional matching, and usage balancing as shown in FIG. 7. Alternative approaches may use alternative combination of processes such as: a variation with usage balancing, regional matching, and endpoint prioritization as shown in FIG. 8; a variation with usage balancing and two tiered regional matching shown in FIG. 9; a variation with only endpoint continuity as shown in FIG. 10.

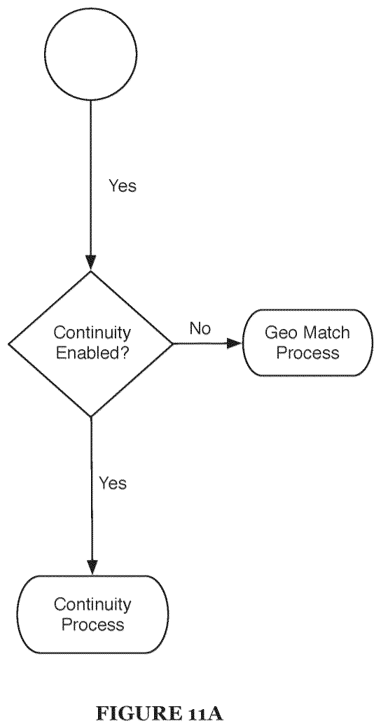

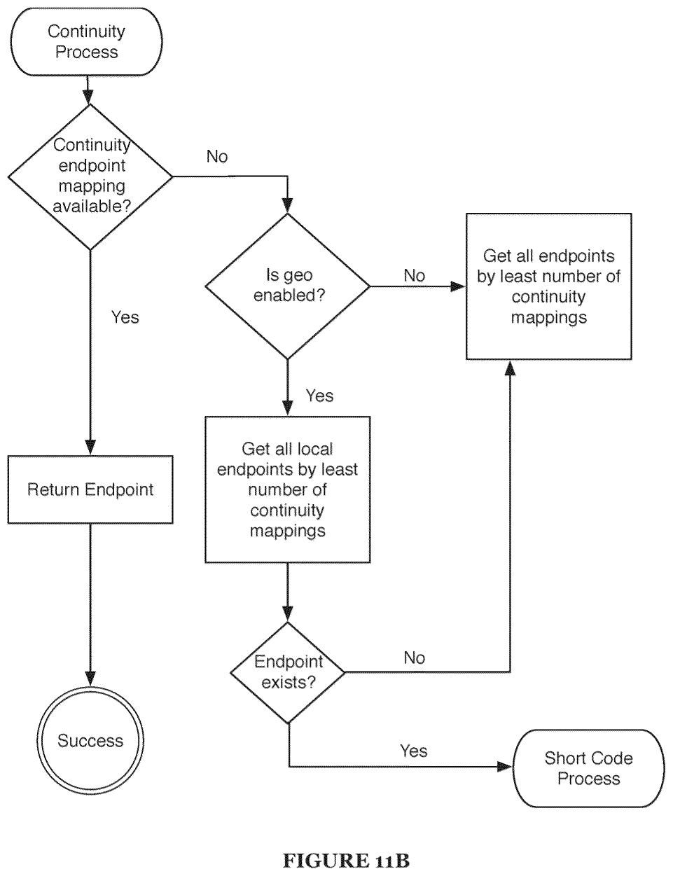

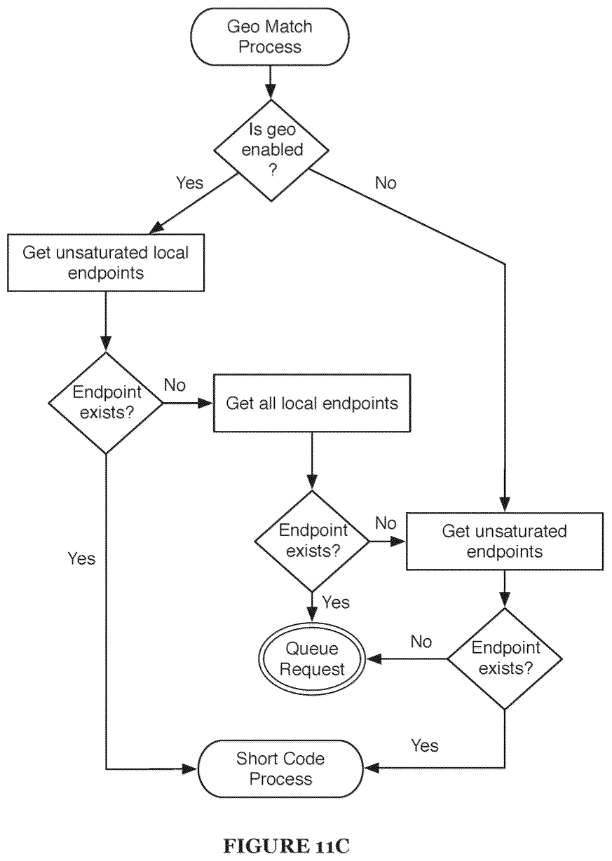

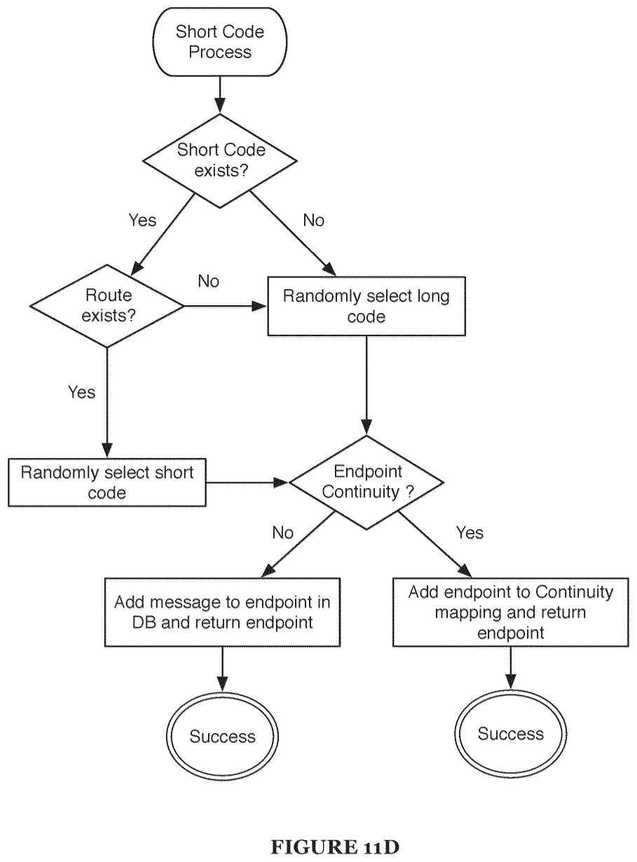

As shown in a detailed representation of FIGS. 11A-11D, one implementation may initially prioritize endpoint continuity (i.e., “stable sender”), then geographic matching, shortcodes, and last longcode endpoints. In this detailed implementation a communication endpoint is preferably selected according to the communication history with the destination endpoint if continuity mapping (e.g., a communication history record) exists indicating that the destination endpoint previously participated in a communication with a communication. If such a continuity mapping does not exit (e.g., a destination endpoint did not previously participate in a communication with a communication endpoint of the entity or that endpoint is not available), a communication endpoint can be selected based in part on geographic association and endpoint type prioritization. First, the country of the destination endpoint is attempted to be matched. If the country can be matched, the area code may optionally be matched. When multiple endpoints are available for selection after regional matching, short code endpoints and/or other endpoint types may be prioritized for selection.

The selection heuristics may additionally factor in alphanumeric endpoints, user specified endpoint preference, destination endpoint properties, or other suitable factors. Selecting an endpoint can include several variations including prioritizing a communication endpoint according to user priority S221, selecting the communication endpoint according to usage of the set of communication endpoints S222, selecting an endpoint according to communication history with the destination endpoint S223, selecting an endpoint according to geographic association with the destination endpoint S224, detecting capacity threshold and allocating endpoints to the set of communication endpoints S225, and/or selecting an endpoint from a shared endpoint pool S226.

Prioritizing a communication endpoint according to user priority S221 functions to apply user preference in selecting a particular endpoint. In one variation, a user may rank endpoints by selection priority. One or more communication endpoints can receive some priority score that can be determined the order in which the communication endpoint selection will be appointed. For example, a user can specify what top three endpoints should receive priority when there is available capacity. A communication endpoint can alternatively or additionally be prioritized according to the type of endpoint or any suitable trait of the endpoint. A user can define customized selection rules, which can depend on any suitable factor. Default prioritization may additionally be used. For example, short codes are prioritized such that a short code is selected before a longcode when possible.

Selecting the communication endpoint according to usage of the set of communication endpoints S222 functions to load balance communications across the set of communication endpoints. The method can include monitoring usage of the set of communication endpoints. Preferably usage is monitored relative to usage restrictions. For example, a communication endpoint may have messaging metrics monitored to determine if the communication endpoint is nearing or exceeding various rate limits or volumes. Some usage restrictions can be based limitations from outside parties such as carriers or internal restrictions of the platform. When selecting a communication endpoint for a particular destination, the usage history of a communication endpoint is evaluated and used in determining if a communication endpoint is eligible for selection. Communications near or over usage restrictions are preferably considered ineligible. Additionally, communication endpoints with low usage may be prioritized for selection to balance usage across the set of communication endpoints. Other selection criteria such as user priority, communication continuity and other rules may additionally be considered in determining the exact approach to how usage is considered.

Selecting an endpoint according to communication history with the destination endpoint S223, functions to apply the endpoint continuity (i.e., “stable sender”) configuration. Endpoint selection can b based on communication history for a destination endpoint that previously participated in communication with a communication endpoint of the entity. If endpoint continuity is enabled, a sender record is maintained that indicates which endpoint is used for the previously messaged destination endpoints. For subsequent message requests, the sender record for a destination endpoint can be queried. If a sender record exists for the destination endpoint, that same origin endpoint can be attempted to be used again. The origin endpoint may not be eligible in some situations depending on usage and other factors. If the destination is a new destination (i.e., there is no sender record), the endpoint selection can be based on other selection heuristics. An additional check may be performed to ensure that the previously used endpoint is still a valid endpoint for the endpoint pool. For example, an endpoint may be removed from an endpoint pool in between two messages to a destination endpoint. Alternatively, the sender records can be updated when an endpoint is removed from an endpoint pool. In some variations, a new endpoint may be used when a previously used endpoint is at capacity. In another variation, the message maybe delayed until the previously used endpoint is available for use. As discussed, there may be various modes of communication continuity such as a last used mode, a most used mode, a geographically nearest mode, or a best fit mode. For example, communication continuity may be used in combination with geographic association so that a communication endpoint the nearest communication endpoint previously used to contact a destination endpoint is prioritized for selection.

Selecting an endpoint according to geographic association with the destination endpoint S224, functions to select an origin endpoint that is associated with a nearby or same geographic region as the destination endpoint. In one variation, the subset of endpoints with the same country code as the destination is considered for selection. In another variation, the subset of endpoints with the same area code as the destination endpoint is considered for selection. In yet another variation, the set of endpoints in the endpoint pool may be prioritized for selection based on geographic proximity. For example, if a destination endpoint has the area code 415 (near San Francisco) then a 510 area code (near Oakland) will be higher priority than a 917 area code (near New York City).

Detecting a capacity threshold and allocating endpoints to the set of communication endpoints S225 functions to autoallocate endpoints. Automatic allocation is preferably performed when autoallocation is activated in an endpoint pool configuration. Detecting a communication capacity threshold can involve sending messages at maximum capacity, sending messages at some percentage of maximum capacity, sending messages at a rate trending towards capacity, or any suitable pattern that may be addressed by allocating more endpoints to the endpoint pool. Autoallocation may select endpoints based on the mix of endpoints existing in the endpoint pool. Autoallocation may select endpoints based on the mix of messaged destination endpoints. In another variation, autoallocation can be based on a user defined setting. Autoallocation may alternatively randomly select new endpoints or allocated new endpoints based on any suitable selection criteria. Endpoints may additionally be automatically released from an endpoint pool. For example, endpoints can be released when messaging capacity subsides or is below a particular threshold for some amount of time.

Selecting an endpoint from a shared endpoint pool S226 functions to use a shared set of communication endpoints. A shared set of communication endpoints is preferably a pool of endpoints usable by a plurality of entities. The shared set of communication endpoints can be provided by any suitable party. In one variation, the platform provider offers access to a shared set of communication endpoints. In another variation, a parent account offers subaccounts access to a shared set of communication endpoints. Shared endpoints can be lower priority endpoints that are used only when the owned endpoints are at capacity. Similar selection heuristics can be applied to the shared endpoint pool when used such matching the geographic region of a destination endpoint.

Block S200 may additionally include requeuing a message request when an endpoint from the endpoint pool is not available. When the set of communication endpoints is at a communication capacity, the request can be requeued, scheduled, or otherwise held to be processed at a later point. In one variation, a time window limit may be set for a particular communication request. If a communication or group of communications cannot be transmitted by the time window limit, the communications can be canceled. For example, in some cases, a user would prefer a message to not be sent than be sent after a particular time window. The time window limit can be specified for a particular message request or in the endpoint configuration.

Block S230, which includes establishing a communication to a destination endpoint from the associated selected communication endpoint, functions to send the message using an origin endpoint selected in Block S220. The recipient of the message will see that the message comes from the endpoint selected for that particular destination. For a communication request specifying a single destination, a single communication can be established. For a bulk communication request that specifies a plurality of destination endpoints, a set of distinct communication can be established. A communication can be attempted for each destination endpoint where a custom selected endpoint is automatically selected for each destination endpoint. In some variations a communication request can result in the communication being segmented into multiple communications. For example, the contents of a messaging request may necessitate the contents of the message request to be split into multiple messages. Establishing a communication can include transmitting an asynchronous message such as an SMS, MMS, IP message, or other suitable form of message. Establishing a communication can alternatively include dialing, calling, or otherwise attempting to establish a synchronous communication channel with at least one destination endpoint. For example, establishing a communication may make a call over the PSTN, make a call over SIP, make a video call, a conference call, start a screen sharing session, or any suitable real-time communication session.

The method can additionally include transforming content of the communication request, which functions to dynamically augment content according to the destination. The content of a communication may be transformed between media mediums. For example, text in a text messaging request may be transformed to text to speech audio, if a PSTN call is established for a particular destination endpoint. In another variation, contents may be translated to different languages based on the destination endpoint.

The method can additionally include reporting endpoint usage S130, which functions to provide analytics and data on how endpoints are being used from the endpoint pool. The endpoint usage can include usage count for each endpoint, percent used within the endpoint pool, the number of times the pool or a particular endpoint was at capacity, and/or other stats. The endpoint usage may additionally include a log of what endpoint was used for what destination. Capacity usage data can help an account holder evaluate if the endpoint pool is sufficient or too large. Automatic notifications based on the endpoint usage may alternatively be generated to notify when endpoints should be added or possibly removed from an endpoint pool.

The method can additionally include controlling messaging through an endpoint pool resource. The endpoint pool resource is preferably an accessible resource such as a REST API resource through which configuration and various aspects of associated communication requests may be managed. Real-time control of queued communications requests can be managed through the endpoint pool. Real-time control may be used for canceling communications, editing destination endpoints of a request, editing message content, or taking any suitable action on a communication. For example, if a bulk messaging request was made, numerous outbound messages may be queued to be sent from a variety of origin endpoints. The communication platform can enable a cancel message request to be directed at the endpoint pool and the unsent messages from that bulk request may be halted. Additionally, other messaging features such as keyword response, customized routing options, and other features can be managed through the endpoint point pool instead of setting up each individual endpoint.

The system and method of the preferred embodiment and variations thereof can be embodied and/or implemented at least in part as a machine configured to receive a computer-readable medium storing computer-readable instructions. The instructions are preferably executed by computer-executable components preferably integrated with the media intelligence platform. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
receiving, through an application programming interface, a set of communication requests directed at an endpoint pool resource, the endpoint pool resource including a set of account phone numbers associated with an account, the set of communication requests specifying a set of destination phone numbers;
for each destination phone number in the set of destination phone numbers, selecting an account phone number from the set of account phone numbers based on a phone number type of a plurality of phone number types; and
initiating outbound communication with the destination phone number from an origin endpoint assigned as the selected account phone number.

2. The method of claim 1, wherein the plurality of phone number types comprises one or more of a longcode type, a short code type, a toll-free number type or an alphanumeric type.

3. The method of claim 1, wherein selecting the account phone number is further based on a determination that a geographic location of a respective destination phone number matches a geographic location of the account phone number.

4. The method of claim 1, wherein selecting the account phone number is further based on a determination that a respective destination phone number did not previously receive a communication from any of the account phone numbers in the set of account phone numbers associated with the account.

5. The method of claim 3, wherein the geographic location of the respective destination phone number matching the geographic location of the account phone number depends on a country code and area code.

6. The method of claim 1, further comprising:
detecting a capacity limit for initiated communications by the account and allocating new account phone numbers to the set of account phone numbers associated with the account.

7. The method of claim 4, further comprising:
receiving user input setting state of a sender continuity option, wherein the determination that the destination phone number did not previously receive a communication from any of the account phone numbers in the set of account phone numbers associated with the account is performed if the state of the sender continuity option is active.

8. The method of claim 1, wherein initiating the outbound communication comprises sending a message to the destination phone number.

9. The method of claim 1, wherein initiating the outbound communication comprises initiating a synchronous communication session with the destination phone number.

10. A non-transitory computer readable medium storing instructions, which when executed by a processing device, cause the processing device to perform operations comprising:
receiving, through an application programming interface, a set of communication requests directed at an endpoint pool resource, the endpoint pool resource including a set of account phone numbers associated with an account, the set of communication requests specifying a set of destination phone numbers;
for each destination phone number in the set of destination phone numbers, selecting an account phone number from the set of account phone numbers based on a phone number type of a plurality of phone number types; and
initiating outbound communication with the destination phone number from an origin endpoint assigned as the selected account phone number.

11. The non-transitory computer readable medium of claim 10, wherein the plurality of phone number types comprises one or more of a longcode type, a short code type, a toll-free number type or an alphanumeric type.

12. The non-transitory computer readable medium of claim 10, wherein selecting the account phone number is further based on a determination that a geographic location of a respective destination phone number matches a geographic location of the account phone number.

13. The non-transitory computer readable medium of claim 10, wherein selecting the account phone number is further based on a determination that a respective destination phone number did not previously receive a communication from any of the account phone numbers in the set of account phone numbers associated with the account.

14. The non-transitory computer readable medium of claim 12, wherein selecting the account phone number based on the determination that the geographic location of the respective destination phone number matches the geographic location of the account phone number is further based on regional proximity of the geographic location of the respective destination phone number and the geographic location of the account phone number.

15. The non-transitory computer readable medium of claim 10, the operations further comprising:
detecting a capacity limit for initiated communications by the account and allocating new account phone numbers to the set of account phone numbers associated with the account.

16. A system comprising:
a memory; and
a processing device, coupled to the memory, to perform operations comprising:
receiving, through an application programming interface, a set of communication requests directed at an endpoint pool resource, the endpoint pool resource including a set of account phone numbers associated with an account, the set of communication requests specifying a set of destination phone numbers;
for each destination phone number in the set of destination phone numbers, selecting an account phone number from the set of account phone numbers based on a phone number type of a plurality of phone number types; and
initiating outbound communication with the destination phone number from an origin endpoint assigned as the selected account phone number.

17. The system of claim 16, wherein the plurality of phone number types comprises one or more of a longcode type, a short code type, a toll-free number type or an alphanumeric type.

18. The system of claim 16, wherein selecting the account phone number is further based on a determination that a geographic location of a respective destination phone number matches a geographic location of the account phone number.

19. The system of claim 16, wherein selecting the account phone number is further based on a determination that a respective destination phone number did not previously receive a communication from any of the account phone numbers in the set of account phone numbers associated with the account.

20. The system of claim 16, the operations further comprising:
detecting a capacity limit for initiated communications by the account and allocating new account phone numbers to the set of account phone numbers associated with the account.
